(19) United States
(12) Patent Application Publication
(10) Pub. No.: US 2026/0222926 A1
(43) Pub. Date: Jul. 30, 2026

(54) ASSISTANCE INFORMATION FOR USER EQUIPMENT CELL HANDOVER BASED ON REFERENCE SIGNAL MEASUREMENTS OF CANDIDATE CARRIER AGGREGATION CONFIGURATIONS

(71) Applicant: QUALCOMM Incorporated, San Diego, CA (US)

(72) Inventors: Kiran VENUGOPAL, Green Brook, NJ (US); Yan ZHOU, San Diego, CA (US); Jing JIANG, San Diego, CA (US)

(21) Appl. No.: 19/039,698

(22) Filed: Jan. 28, 2025

(51) Int. Cl. H04W 36/00; H04L 5/00; H04W 36/30

(52) U.S. Cl. CPC H04W 36/0072; H04L 5/001; H04W 36/30

(57) ABSTRACT

Systems and techniques are provided for wireless communications. For example, a network entity can receive information indicative of a mapping between reference signals and a set of component carriers (CCs) for a plurality of candidate CA configurations included a neighbor cell list for the network entity. Performance information indicative of respective values for each CC of the set of CCs can be used to determine estimated cell throughput information for each candidate CA configuration in the neighbor cell list, based on the performance information and reference signal measurements obtained according to the mapping for each CC of the set of CCs associated with a respective candidate CA configuration. The network entity can transmit cell reselection information for handover of the network entity, indicative of a ranked order of the neighbor cell list, the ranked order determined according to the estimated cell throughput information for each candidate CA configuration.

### INTRODUCTION

Aspects of the present disclosure generally relate to wireless communication. In some implementations, examples are described for cell handover of a network device based on reference signal measurements of one or more component carriers (CCs) corresponding to a candidate carrier aggregation (CA) configuration.

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a network entity for wireless communication is provided. The network entity includes a processing system, where the processing system is configured to: receive information indicative of a mapping between one or more reference signals and a set of component carriers (CCs) associated with each candidate carrier aggregation (CA) configuration of a plurality of candidate CA configurations included a neighbor cell list associated with the network entity; receive performance information indicative of one or more respective values for each CC of the set of CCs associated with each candidate CA configuration; determine estimated cell throughput information for each candidate CA configuration included in the neighbor cell list, the estimated cell throughput information for a respective candidate CA configuration based on: the performance information and one or more reference signal measurements obtained according to the mapping for each CC of the set of CCs associated with the respective candidate CA configuration; and transmit cell reselection information for handover of the network entity, wherein the cell reselection information is indicative of a ranked order of the neighbor cell list, the ranked order determined according to the estimated cell throughput information for each candidate CA configuration.

In another example, a method for wireless communication is provided, the method including: receiving information indicative of a mapping between one or more reference signals and a set of component carriers (CCs) associated with each candidate carrier aggregation (CA) configuration of a plurality of candidate CA configurations included a neighbor cell list associated with a network entity; receiving performance information indicative of one or more respective values for each CC of the set of CCs associated with each candidate CA configuration; determining estimated cell throughput information for each candidate CA configuration included in the neighbor cell list, the estimated cell throughput information for a respective candidate CA configuration based on: the performance information and one or more reference signal measurements obtained according to the mapping for each CC of the set of CCs associated with the respective candidate CA configuration; and transmitting cell reselection information for handover of the network entity, wherein the cell reselection information is indicative of a ranked order of the neighbor cell list, the ranked order determined according to the estimated cell throughput information for each candidate CA configuration.

In another example, a non-transitory computer-readable storage medium is provided comprising instructions stored thereon which, when executed by at least one processor, causes the at least one processor to: receive information indicative of a mapping between one or more reference signals and a set of component carriers (CCs) associated with each candidate carrier aggregation (CA) configuration of a plurality of candidate CA configurations included a neighbor cell list associated with the network entity; receive performance information indicative of one or more respective values for each CC of the set of CCs associated with each candidate CA configuration; determine estimated cell throughput information for each candidate CA configuration included in the neighbor cell list, the estimated cell throughput information for a respective candidate CA configuration based on: the performance information and one or more reference signal measurements obtained according to the mapping for each CC of the set of CCs associated with the respective candidate CA configuration; and transmit cell reselection information for handover of the network entity, wherein the cell reselection information is indicative of a ranked order of the neighbor cell list, the ranked order determined according to the estimated cell throughput information for each candidate CA configuration.

In another example, an apparatus is provided for wireless communication. The apparatus includes: means for receiving information indicative of a mapping between one or more reference signals and a set of component carriers (CCs) associated with each candidate carrier aggregation (CA) configuration of a plurality of candidate CA configurations included a neighbor cell list associated with a network entity; means for receiving performance information indicative of one or more respective values for each CC of the set of CCs associated with each candidate CA configuration; means for determining estimated cell throughput information for each candidate CA configuration included in the neighbor cell list, the estimated cell throughput information for a respective candidate CA configuration based on: the performance information and one or more reference signal measurements obtained according to the mapping for each CC of the set of CCs associated with the respective candidate CA configuration; and means for transmitting cell reselection information for handover of the network entity, wherein the cell reselection information is indicative of a ranked order of the neighbor cell list, the ranked order determined according to the estimated cell throughput information for each candidate CA configuration.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5A is a diagram illustrating an example of physical channels and reference signals in a wireless network, in accordance with some examples;

FIG. 5B is a diagram illustrating an example of an aggregated bandwidth for carrier aggregation (CA) using a CA configuration for a plurality of component carriers (CCs), in accordance with some examples;

FIG. 6 is a diagram illustrating an example of a configuration of a wireless communication network including a serving cell and one or more neighboring cells associated with a UE, in accordance with some examples;

FIG. 7 is a diagram illustrating an example of a configuration of a wireless communication network corresponding to idle UE cell reselection based on respective frequency information for a plurality of neighboring cells, in accordance with some examples;

FIG. 8 is a flowchart diagram illustrating an example of a process for wireless communications by a network entity, in accordance with some examples; and

FIG. 9 is a block diagram illustrating an example of a computing system, which may be employed by the disclosed systems and techniques, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

In various communication protocols (e.g., 4G/LTE, 5G/NR, 6G, etc.), a UE can perform measurements of radio conditions. The measurements can include intra-frequency measurement and inter-frequency measurement. For example, intra-frequency measurement may refer to measurements that are to be performed when the cell in which the UE is currently located and the target cell to be measured are on a same carrier frequency (for example, the center frequency). Inter-frequency measurement may refer to measurements that are to be performed when the cell in which the UE is currently located and the target cell are not on a same carrier frequency.

Performing inter-frequency measurement corresponds to a UE receiving signals at two different radio frequencies (e.g., a first frequency corresponding to the serving/local cell and a second frequency corresponding to a neighboring/target cell). In some examples, the UE can be configured with one or more measurement gaps for performing an inter-frequency measurement (e.g., which may include inter-radio access technology (inter-RAT) measurement), where the measurement gap is a time period or time interval within which normal data transmission and reception between the UE and its serving cell is interrupted while the UE tunes its RF receiver to the frequency of the neighboring/target cell being measured by the inter-frequency or inter-RAT measurement(s). At the end of the measurement gap and the inter-frequency or inter-RAT measurement(s), the UE may return to its current cell to continue (e.g., resume) data transmission and reception on the serving cell.

Connected UE mobility procedures can be used in a wireless communication network (e.g., including 4G/LTE, 5G/NR, 6G, etc.) to maintain a connection between a UE and the network, as the UE moves between or switches between different cells while transmitting or receiving data. Connected UE mobility procedures can be used to provide seamless communication and to minimize or reduce dropped connections during cell switching (e.g., cell handover) events for the UE. In some examples, connected UE mobility can be configured by the network (e.g., a network entity, base station, gNB, etc.) for one or more UEs. For example, connected UE mobility may be controlled by the network with assistance or feedback (e.g., report information, measurement information, etc.) provided from the UE to the network and/or network entity thereof.

In some cases, UE mobility procedures and/or UE mobility management can be implemented based on the UE performing one or more measurements of a configured set of one or more reference signals (RSs) transmitted by the network. For example, the UE may continuously, periodically, and/or aperiodically, etc., monitor one or more respective reference signals transmitted by the current serving cell of the UE and transmitted by a set of candidate cells for potential handover. The candidate cells for the potential handover of the UE may be neighboring cells that are adjacent to and/or nearby the current serving cell of the UE. A set of candidate cells for potential handover may be configured for the UE by the network (e.g., a network entity can transmit information indicative of the set of candidate cells for handover to the UE), may be identified or determined by the UE, or various combinations thereof.

Based on the measurement information determined by the UE for the respective reference signals transmitted by the serving cell and neighboring (e.g., candidate) cells, the UE may transmit one or more measurement reports for UE mobility management. In some cases, the measurement reports can be indicative of a respective measured value of the reference signal(s) for one or more of the configured candidate cells for potential handover. For example, the UE may actively measure the quality of downlink signals (e.g., reference signals, etc.) from the serving cell and detectable neighboring cells. The measurements can include one or more of reference signal received power (RSRP) measurements, reference signal received quality (RSRQ) measurements, signal-to-interference-plus-noise ratio (SINR) measurements, etc., on one or more neighboring cells (e.g., candidate cells for the potential handover, also referred to as target cells).

In some examples, in 5G NR networks, a UE can be configured with a set of candidate cells for handover by the network, for the purpose of connected UE mobility. The UE can obtain one or more measurements of one or more reference signals corresponding to each respective candidate cell of the set of candidate cells. For example, the UE can determine a measured RSRP of the reference signal(s) transmitted by each candidate cell in the configured set of candidate cells. The UE can perform measurement reporting to the network (e.g., a network entity, base station, gNB, etc.), for example by transmitting to the network entity a measurement report indicative of the measured RSRP for each candidate cell. In some cases, the measurement report can include the measured RSRP values of the various candidate cells. In some examples, the measurement report can indicate a ranked order, list, or sequence of the candidate cells according to the RSRP values measured by the UE, without the measurement report including the measured RSRP values.

Candidate cell selection can be performed for the UE handover by selecting a candidate cell from the set of candidate cells based on a decreasing order of the measured RSRP determined by the UE. For example, the candidate cell with the best RSRP measurement may be listed first in the measurement report transmitted to the network entity, and may be selected as the target cell in a handover decision determined by the network entity for the UE. In some cases, the UE can perform measurement reporting for the candidate cells for handover or UE mobility as ordered list reporting (e.g., the UE can transmit an ordered list of the candidate cells based on or ranked according to the respective signal strength and/or quality measured by the UE for each respective candidate cell).

In some cases, the candidate cell with the best RSRP can be different from the candidate cell with the best throughput. It may be beneficial for UE mobility management to be performed based on factors other than, or in addition to, the RSRP or link quality alone for each candidate cell. For example, it may be beneficial for UE candidate cell handover determinations to be implemented using measurement reports that are indicative of throughput information for one or more candidate cells for handover of a UE.

Systems, apparatuses, processes (also referred to as methods), and computer-readable media (collectively referred to as “systems and techniques”) are described herein that can be used to provide UE mobility and/or cell handover based on a throughput metric-based candidate cell selection for the handover. For example, the systems and techniques can be used to implement UE mobility and handover based on measurements and/or estimations of the quality or performance of a set of candidate cells using additional factors beyond RSRP alone. For example, in some cases, the candidate cell with the best RSRP may be different from the candidate cell with the best throughput.

6G networks may be configured to implement a throughput-based metric for candidate cell selection during UE mobility events and/or for UE handover procedures. For example, a 6G network may be implemented where UEs are configured to report or select candidate cells based on an order of the candidate cell's respective throughputs. To determine the respective throughput for each candidate cell, the UE may perform throughput estimation based on link quality information measured by the UE for each candidate cell (e.g., link quality information determined based on UE measurements of reference signals transmitted by each candidate cell, etc.) and assistance information provided from the network (e.g., network entity, etc.) to the UE.

For example, the assistance information provided to the UE for estimation of candidate cell throughput can include one or more of respective bandwidth(s) for each candidate cell, MIMO capabilities associated with each candidate cell, the number of MIMO layers that are supported by each candidate cell, existing loads for each candidate cell, etc. Based on the assistance information, the UE can estimate the throughput(s) that can be available from the candidate cells after a potential handover or UE mobility event to switch away from the UE's current serving cell to a selected one of the candidate cells.

In some cases, the assistance information for the UE-implemented candidate cell throughput estimation may be implemented as measurement priority information that does not disclose the detailed information of each candidate cell (e.g., such as the bandwidth(s), MIMO capabilities, MIMO layers, existing loads, etc.). For example, the priority information of the network assistance information may be used by the UE to determine an ordered priority ranking of the candidate cells that corresponds to a respective throughput estimate for each candidate cell, without the UE determining a specific value of the estimated throughput of each candidate cell. For example, the network entity (e.g., base station, gNB, etc.) can provide the UE with assistance information that indicates a measurement priority per candidate cell and/or per frequency. In some cases, the measurement priority may be indicative of a higher priority for candidate cells with a larger bandwidth, a higher priority for candidate cells with lower existing load(s), and/or a higher priority for candidate cells that may be better for throughput, etc.

Based on the link quality of each candidate cell (e.g., determined by the UE based on respective reference signal measurements for the candidate cell) and the assistance information provided from the network entity to the UE for the throughput estimation or prioritization for handover, the UE may perform handover or mobility to switch from the current serving cell to a best candidate cell with the greatest available throughout for the UE. For example, a UE may select a TDD cell offering better throughput than an FDD cell, even though the TDD cell has a weaker link (e.g., lower RSRP) to the UE than the FDD cell.

In some aspects, the systems and techniques can be used to implement network assistance information for a UE perform throughput-based handover candidate cell selection from a plurality of candidate cells associated with the UE, where at least a portion of the plurality of candidate cells are carrier aggregation (CA) cells that include multiple component carriers combined according to a respective CA configuration. In a multi-carrier system, such as 5G, one of the carrier frequencies for a cell is referred to as the “primary carrier” or “anchor carrier” or “primary serving cell” or “PCell,” and the remaining carrier frequencies are referred to as “secondary carriers” or “secondary serving cells” or “SCells.” In some examples, the systems and techniques can be used to provide the handover candidate cell selection for one or more CA configurations based on the UE being configured to obtain link quality measurements for multiple component carriers (CCs) of the set of CCs included in a CA configuration. For example, the UE can obtain link quality measurements for the primary cell (PCell) of a CA configuration, and can further obtain link quality measurements for one or more secondary serving cells (SCells) of the same CA configuration. The UE can measure and/or estimate link quality of one or more CCs of each candidate CA configuration of a plurality of candidate CA configurations for a UE mobility event or handover operation, rather than only the primary CC as may be implemented in 5G NR networks.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, a processing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, processing system, or the like may include disclosure of the UE, base station, apparatus, device, computing system, processing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first processing system, a first one or more components, a first processing entity, or the like configured to receive the information; and the second network node may refer to a second UE, a second base station, a second apparatus, a second device, a second computing system, a second processing system, a second one or more components, a second processing entity, or the like.

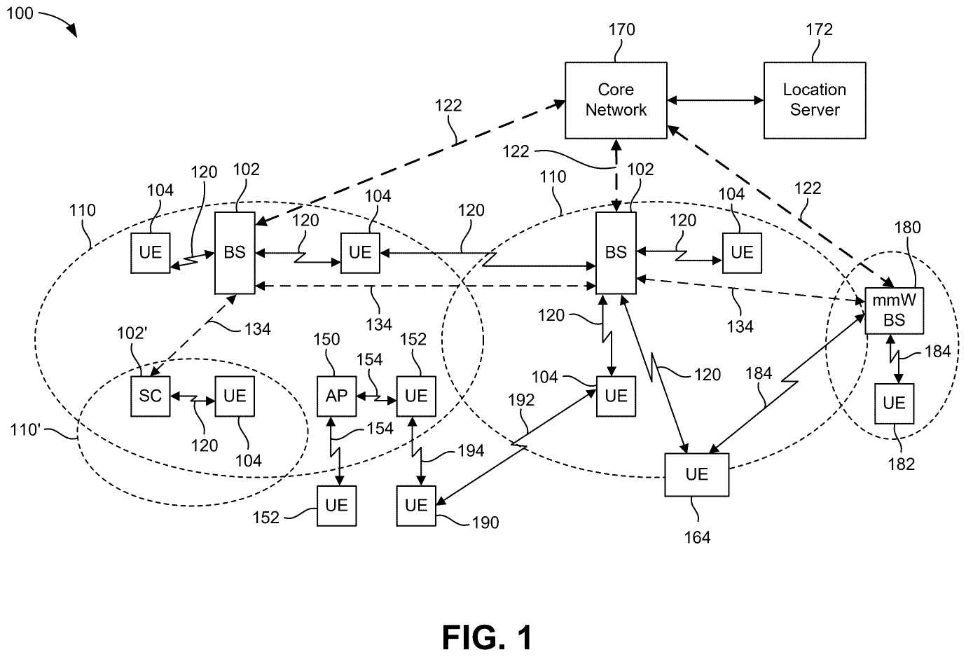

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, a processing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 100 of FIG. 1. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, network node, apparatus, device, computing system, processing system or the like may include disclosure of the UE, base station, network node, apparatus, device, computing system, processing system or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first processing system, a first set of one or more one or more components, a first processing entity, or the like configured to receive the information; and the second network entity may refer to a second UE, a second base station, a second apparatus, a second device, a second computing system, a second processing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

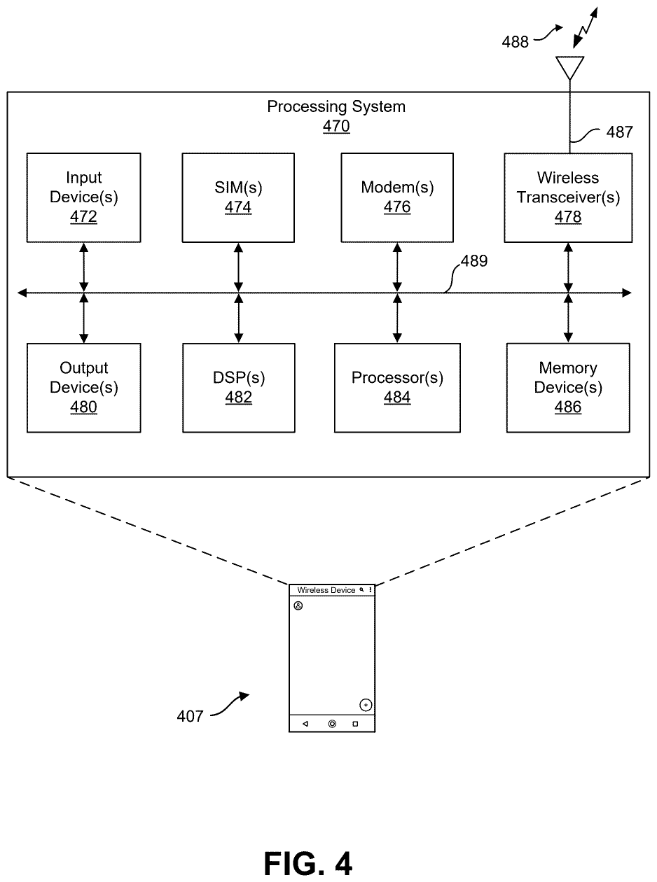

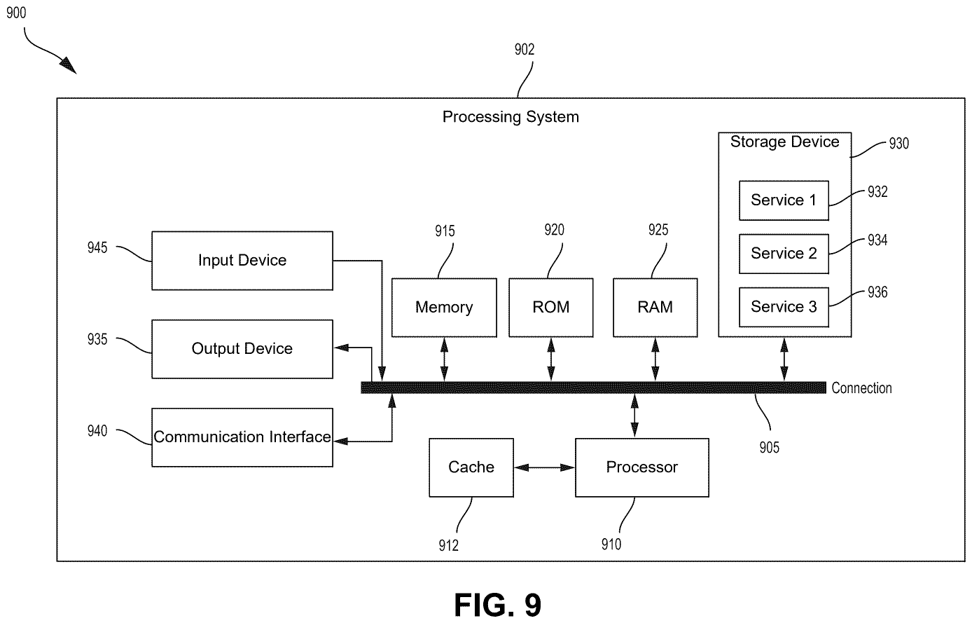

In some examples, the network entity 102 may include a processing system (e.g., such as the processing system 470 of FIG. 4 and/or the processing system 902 of FIG. 9, etc.). Similarly, the network entity 180 (e.g., a millimeter wave (mmW) base station, etc.) may include a respective processing system (e.g., such as the processing system 470 of FIG. 4 and/or the processing system 902 of FIG. 9, etc.). A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system May include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 102 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

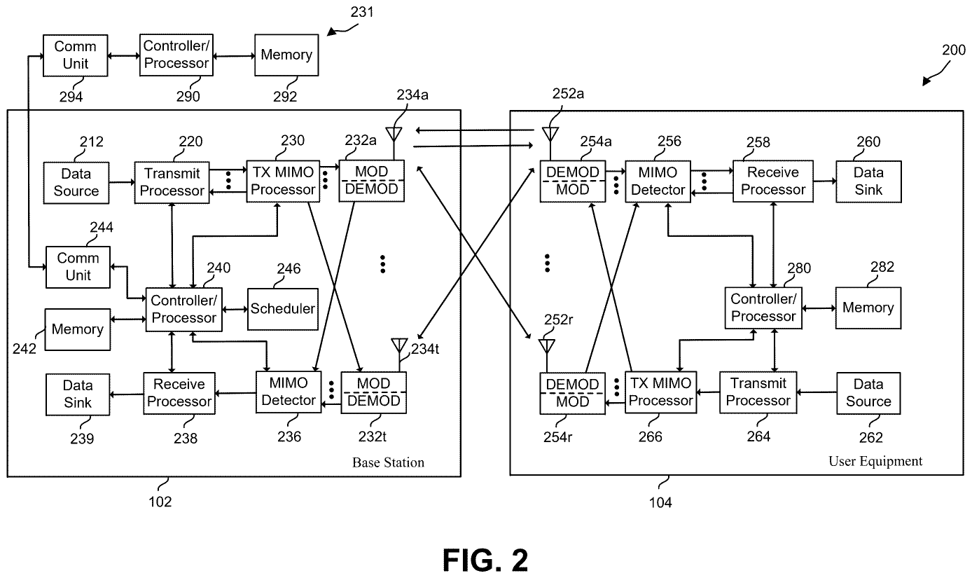

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

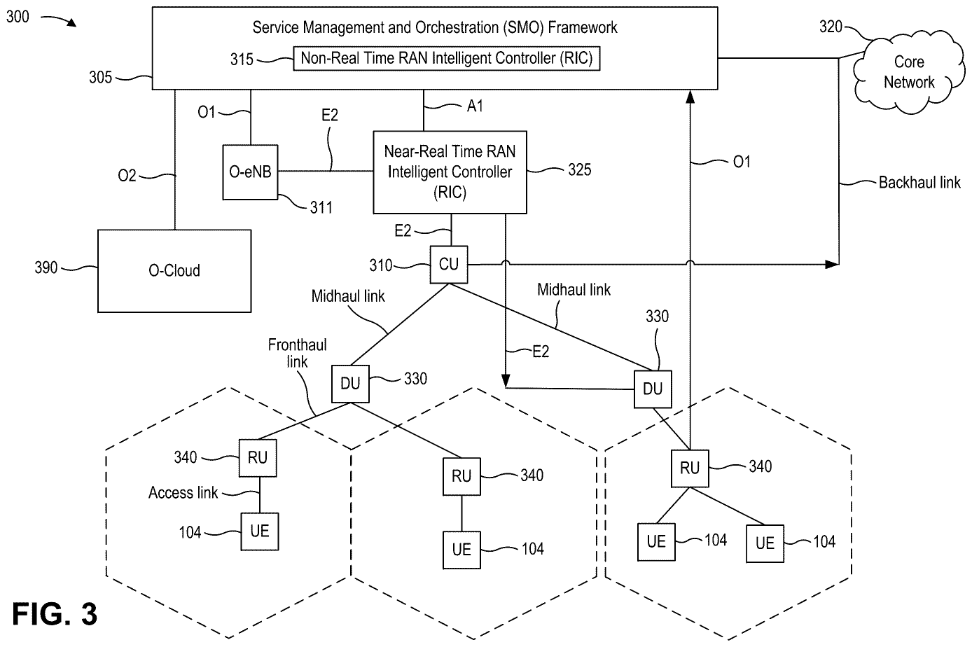

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUS 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via 01) or via creation of RAN management policies (e.g., such as A1 policies).

FIG. 4 illustrates an example of a processing system 470 of a wireless device 407. In some examples, the processing system 470 may also be referred to as a computing system. The processing system 470 may include and/or implement one or more components that are the same as or similar to respective components included in and/or implemented by the processing system 902 of FIG. 9 (e.g., and the processing system 902 of FIG. 9 may include and/or implement one or more components that are the same as or similar to respective components included in and/or implemented by the processing system 470 of FIG. 4). In some cases, the wireless device 407 may also be referred to as a user computing device. The wireless device 407 may include a client device such as a UE (e.g., UE 104, UE 152, UE 190) or other type of device (e.g., a station (STA) configured to communication using a Wi-Fi interface) that may be used by an end-user. In some cases, the processing system 470 of the wireless device 407 can be implemented by one or more of the UEs 104 of FIG. 1. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network.

The processing system 470 includes software and hardware components that may be electrically or communicatively coupled via a bus 489 (e.g., or may otherwise be in communication, as appropriate). The processing system 470 may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. For example, the processing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The processing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, processing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the processing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the processing system 470 may include a coding-decoding device (or CODEC) configured to encode and/or decode data transmitted and/or received using the one or more wireless transceivers 478. In some cases, the processing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The processing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The processing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

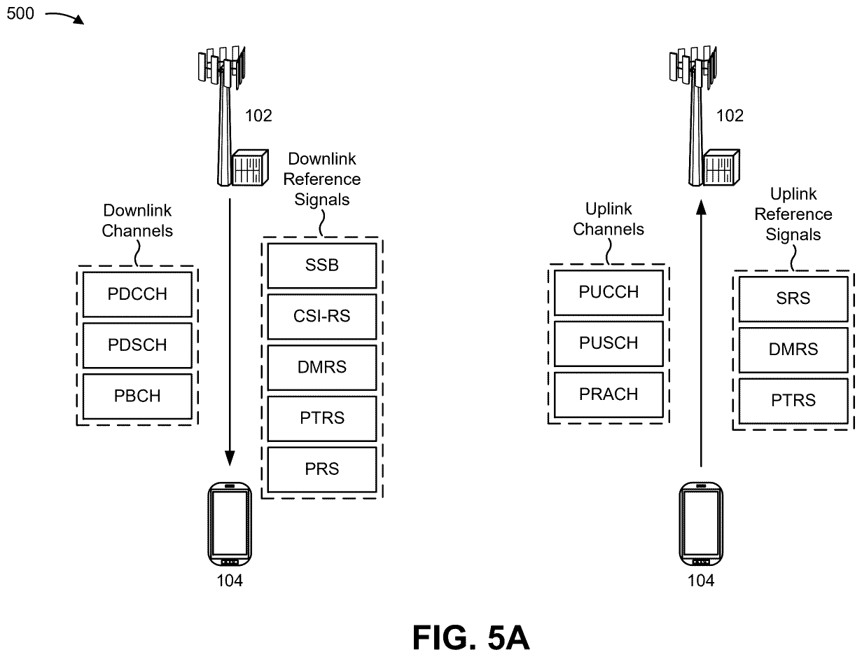

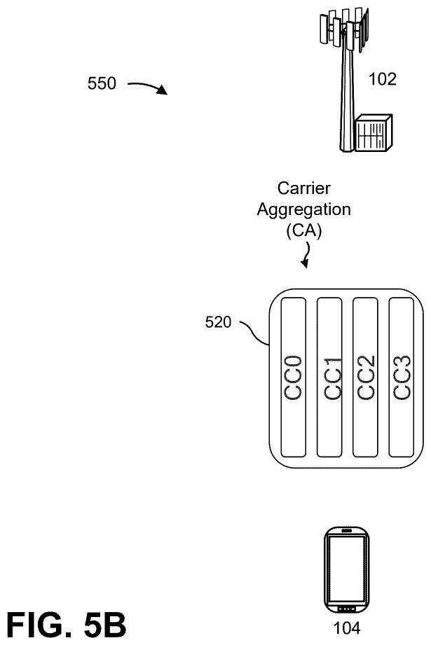

FIG. 5A is a diagram illustrating an example 500 of physical channels and reference signals in a wireless network. In some examples, one or more downlink channels and one or more downlink reference signals may carry information from a base station 102 to a UE 104. One or more uplink channels and one or more uplink reference signals may carry information from UE 104 to base station 102.

In some aspects, a downlink channel may include one or more of a physical downlink control channel (PDCCH) that carries downlink control information (DCI), a physical downlink shared channel (PDSCH) that carries downlink data, and/or a physical broadcast channel (PBCH) that carries system information, among other examples. In some aspects, PDSCH communications may be scheduled by PDCCH communications.

In some examples, an uplink channel may include one or more of a physical uplink control channel (PUCCH) that carries uplink control information (UCI), a physical uplink shared channel (PUSCH) that carries uplink data, and/or a physical random access channel (PRACH) used for initial network access, among other examples. In some aspects, UE 104 may transmit acknowledgement (ACK) or negative acknowledgement (NACK) feedback (e.g., ACK/NACK feedback or ACK/NACK information) in UCI on the PUCCH and/or the PUSCH.

In some cases, a downlink reference signal may include one or more of a synchronization signal block (SSB), a channel state information (CSI) reference signal (CSI-RS), a demodulation reference signal (DMRS), a positioning reference signal (PRS), and/or a phase tracking reference signal (PTRS), among other examples. In some examples, an uplink reference signal may include one or more of a sounding reference signal (SRS), a DMRS, and/or a PTRS, among other examples.

An SSB may carry or include information used for initial network acquisition and synchronization. For example, an SSB can carry or include one or more of a primary synchronization signal (PSS), a secondary synchronization signal (SSS), a PBCH, and/or a PBCH DMRS. An SSB may also be referred to as a synchronization signal/PBCH (SS/PBCH) block. In some aspects, base station 102 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. For example, base station 102 can configure a set of CSI-RSs for UE 104, and UE 104 can measure the configured set of CSI-RSs. Based on the CSI-RS measurements, UE 104 can perform channel estimation and report channel estimation parameters to base station 102 (e.g., in a CSI report). For example, the channel estimation parameters can include one or more of a channel quality indicator (CQI), a precoding matrix indicator (PMI), a CSI-RS resource indicator (CRI), a layer indicator (LI), a rank indicator (RI), and/or a reference signal received power (RSRP), among other examples.

In some examples, base station 102 can use the CSI report to select transmission parameters for downlink communications to UE 104. For example, base station 102 can use the CSI report to select transmission parameters that include one or more of a quantity of transmission layers (e.g., a rank), a precoding matrix (e.g., a precoder), a modulation and coding scheme (MCS), and/or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

APTRS can carry information used to compensate for oscillator phase noise. In some cases, oscillator phase noise may increase as an oscillator carrier frequency increases. In some examples, a PTRS can be utilized at high carrier frequencies (e.g., such as millimeter wave frequencies) to mitigate oscillator phase noise. The PTRS may be used to track the phase of the local oscillator and to enable suppression of phase noise and common phase error (CPE). As illustrated in FIG. 5A, in some examples one or more PTRSs can be used for both downlink communications (e.g., on the PDSCH) and uplink communications (e.g., on the PUSCH).

A PRS may carry information associated with timing or ranging measurements of UE 104. For example, UE 104 may utilize one or more signals (e.g., PRSs) transmitted by base station 102 to improve an observed time difference of arrival (OTDOA) positioning performance. In some examples, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). A PRS can be designed to improve detectability by UE 104, which may need to detect downlink signals from multiple neighboring base stations in order to perform OTDOA-based positioning. Accordingly, UE 104 may receive a PRS from multiple cells (e.g., a reference cell and one or more neighbor cells), and may report a reference signal time difference (RSTD) based on OTDOA measurements associated with the PRSs received from the multiple cells. In some aspects, base station 102 can calculate a position of UE 104 based on the RSTD measurements reported by UE 104.

In some examples, an SRS can carry information used for uplink channel estimation, which may be used for scheduling, link adaptation, precoder selection, and/or beam management, among other examples. Base station 102 can configure one or more SRS resource sets for UE 104, and UE 104 can transmit SRSs on the configured SRS resource sets. An SRS resource set may have a configured usage, such as uplink CSI acquisition, downlink CSI acquisition for reciprocity-based operations, uplink beam management, among other examples. Base station 102 may measure the SRSs, may perform channel estimation based on the measurements, and/or may use the SRS measurements to configure communications with UE 104.

FIG. 5B is a diagram illustrating an example carrier aggregation (CA) configuration 550 with an aggregated bandwidth 520 associated with carrier aggregation in a wireless network including the network entity (e.g., base station, gNB, etc.) 102 and the UE 104. In some cases, the aggregated bandwidth 520 may also be referred to as a CA bandwidth or an aggregated CA bandwidth. The aggregated bandwidth 520 (e.g., aggregated CA bandwidth 520) can be associated with carrier aggregation in the same wireless network that includes the base station 102 and the UE 104. For example, communications between the base station 102 and the UE 104 can be performed using the aggregated CA bandwidth 520. In some aspects, carrier aggregation can be a type of flexible spectrum integration (FSI) and/or an FSI technique.

Carrier aggregation can be implemented using multiple component carriers (CCs) that are aggregated for uplink and/or downlink operations between a network entity (e.g., base station 102) and a UE (e.g., UE 104). For example, in 5G NR, carrier aggregation may be performed to aggregate up to 16 CCs, each with a bandwidth of up to 100 MHz in FR1 (e.g., sub-6 GHz frequency range), or up to 400 MHz in FR2 (e.g., mmWave). The aggregation of the multiple CCs can be implemented under a single scheduler.

In one illustrative example, the aggregated CA bandwidth 520 can include a plurality of aggregated component carriers (CCs). For example, the aggregated CA bandwidth 520 includes the four CCs CC0, CC1, CC2, and CC3. The aggregated component carriers CC0-CC3 can be adjacent carriers from within the same frequency band, corresponding to an intra-band contiguous CA configuration for the aggregated CA bandwidth 520. In another example, the aggregated component carriers CC0-CC3 can be non-adjacent carriers from within the same frequency band, corresponding to an intra-band non-contiguous CA configuration. In another example, the aggregated component carriers CC0-CC3 can be adjacent or non-adjacent carriers that are in different frequency bands, corresponding to an inter-band CA configuration. In some aspects, CCs associated with carrier aggregation can be used as respective sub-bands (SBs) for a virtual cell or virtual carrier. Various carrier aggregation techniques can correspond to using the resources within each CC as disjoint sets of resources, with separate physical layer (PHY) and media access control layer (MAC) operations performed for each CC. For example, the number of PHY and/or MAC operations associated with a CA implementation can scale linearly with the number of CCs that are being aggregated. As used herein, a sub-band (SB) can also refer to a physical carrier (or portion thereof) that is configured as a component carrier for carrier aggregation (e.g., an SB can be a CA CC, and a CA CC can be an SB, etc.).

Carrier aggregation can be implemented to integrate multiple CCs to form a virtual carrier or virtual cell. For example, the virtual cell can be the aggregated CA bandwidth 520 and/or various other integrations of CCs in the same or different band to form the single virtual carrier/cell. In some aspects, the aggregated CA bandwidth 520 can be implemented as a single cell for scheduling and/or UE mobility management and/or handover operations performed by the wireless network. For example, the UE 104 and the base station 102 can perform communications using the aggregated CA bandwidth 520 as a single cell (e.g., the virtual cell of the aggregated CA bandwidth 520 is used as a single serving cell entity, a single neighboring cell and/or candidate handover neighboring cell entity, etc.). In some CA implementations, the number of PHY and/or MAC operations performed for the aggregated CA bandwidth 520 may increase as the number of CCs aggregated within the aggregated CA bandwidth 520 increases. In some cases small and scattered frequency division duplexing (FDD) channels can be integrated as one virtual carrier having the aggregated CA bandwidth 520, where the FDD channels each comprise one or more CCs.

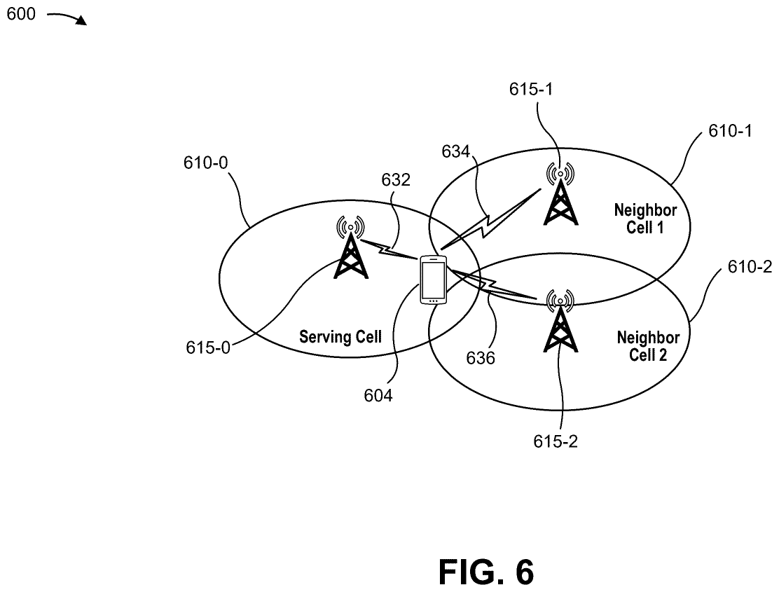

FIG. 6 is a diagram illustrating an example of a configuration of a wireless communication network 600 including a serving cell and one or more neighboring cells that are included in a plurality of cells associated with a UE. For example, the wireless communication network 600 can include a serving cell 610-0 associated with a UE 604. The wireless communication network 600 can include one or more neighboring cells (e.g., first neighbor cell 610-1, second neighbor cell 610-2, etc.) associated with the same UE 604. Each cell of the plurality of cells can include one or more network entities, such as a base station, gNB, etc. For example, the serving cell 610-0 includes a network entity 615-0, the first neighboring cell 610-1 includes a network entity 615-1, the second neighboring cell 610-2 includes a network entity 615-2, etc. In some cases, a cell or cell site of the wireless communication network (e.g., serving cell 610-0, neighboring cell 610-1, neighboring cell 610-2, etc.) may comprise a single cell, which may be an FDD cell or a TDD cell. In some examples, a cell or cell site of the wireless communication network (e.g., serving cell 610-0, neighboring cell 610-1, neighboring cell 610-2, etc.) may include two co-located cells (e.g., a first FDD cell and a second TDD cell, etc.). In some cases, a bandwidth of the co-located TDD cell may be larger than a bandwidth of the co-located FDD cell, and the co-located TDD cell may be assigned a higher priority based on the relatively larger bandwidth.

In some aspects, the wireless communication network 600 of FIG. 6 can be the same as or similar to a wireless communication network 170 or other wireless communication network of FIG. 1. In some examples, the plurality of cells 610-0, 610-1, 610-2 of FIG. 6 can be the same as or similar to one or more of the cells or geographic coverage areas 110 or 110′ of FIG. 1. In some cases, the one or more network entities 615-0, 615-1, 615-2 may be the same as or similar to the base station 102 and/or mmW base station 180 of FIG. 1, the base station 102 of FIG. 2, the network entity 102 of FIG. 5A, etc. A UE 604 can be the same as or similar to one or more of the UEs of FIG. 1, the UE 104 of FIG. 2, the UEs 104 of FIG. 3, the UE 407 of FIG. 4, the UE 104 of FIG. 5A, etc.

In various communication protocols (e.g., 4G LTE, 5G NR, etc.), the UE 604 can perform measurements of radio conditions. The measurements can include intra-frequency measurements and/or inter-frequency measurements. For example, intra-frequency measurements may refer to measurements that are to be performed when the cell in which the UE 604 is currently located (e.g., the serving cell 610-0) and the neighboring cell to be measured (e.g., cell 610-1 and/or 610-2) are on a same carrier frequency (for example, the center frequency). Inter-frequency measurements may refer to measurements that are to be performed when the cell in which the UE 604 is currently located (e.g., serving cell 610-0) and the neighboring cell to be measured (e.g., cell 610-1 and/or 610-2) are not on a same carrier frequency.

For example, if the serving cell 610-0 and the first neighboring cell 610-1 are on a same carrier frequency (e.g., the signal 632 transmitted from the network entity 615-0 of the serving cell 610-0 uses the same carrier frequency as the respective signal 634 transmitted by the network entity 615-1 of the first neighboring cell 610-1), the UE 604 can perform intra-frequency measurement of the one or more signals 634 associated with the first neighboring cell 610-1. If the serving cell 610-0 and the second neighboring cell 610-2 are not on a same carrier frequency (e.g., the signal 632 transmitted by the network entity 615-0 of the serving cell 610-0 uses a different carrier frequency than the signal 636 transmitted by the network entity 615-2 of the second neighboring cell 610-2), the UE 604 can perform inter-frequency measurement of the one or more signals 636 associated with the second neighboring cell 610-2.

To perform inter-frequency measurement, the UE 604 may perform signal reception at two different radio frequencies (e.g., a first frequency corresponding to the serving/local cell 610-0 and a second frequency corresponding to a neighboring/target cell 610-1 or 610-2). In some examples, the UE 604 can be configured with one or more measurement gaps for performing the inter-frequency measurement (including inter-RAT measurement). A measurement gap (MG) is a time period (e.g., a time interval) that interrupts the normal data transmission and reception between the UE 604 and its serving cell 610-0. During an MG occasion, the UE 604 does not send or receive any data using the serving/local cell 610-0, and instead tunes its RF receiver to the frequency of the neighboring/target cell 610-1 or 610-2 to perform the one or more inter-frequency or inter-RAT measurements. At the end of the MG occasion (e.g., when the time of the MG is over), the UE 604 returns to its current serving cell 610-0 to continue (e.g., resume) data transmission and reception.

In some aspects, measurement gaps can be implemented in a wireless communication network as configured intervals of time during which a UE temporarily suspends its regular communication activities (e.g., uplink and/or downlink) to perform measurements of the radio conditions of different frequencies and/or RATs of the wireless communication network. For example, the MG can be a period for measurements on an inter-frequency (e.g., associated with a neighboring cell of the UE) that is different from that of a serving cell of the UE. The measurements can include reference signal received power (RSRP) measurements, reference signal received quality (RSRQ) measurements, signal-to-interference-plus-noise ratio (SINR) measurements, etc., on one or more neighboring cells (e.g., also referred to as target cells). During an MG occasion (e.g., the configured interval of time associated with a measurement gap), a UE may temporarily suspend regular uplink and downlink communications with a serving cell of the network to perform one or more inter-frequency measurements of a neighboring cell of the network. The inter-frequency measurements obtained by the UE 604 during an MG occasion can be used for operations such as inter-frequency and inter-RAT mobility, beamforming management, spectrum sharing, etc.

As noted above, in some examples, a UE can be configured with a set of candidate cells for handover by the network, for the purpose of connected UE mobility. The UE can obtain one or more measurements of one or more reference signals corresponding to each respective candidate cell of the set of candidate cells. For example, the UE can determine a measured RSRP of the reference signal(s) transmitted by each candidate cell in the configured set of candidate cells. The UE can perform measurement reporting to the network (e.g., a network entity, base station, gNB, etc.), for example by transmitting to the network entity a measurement report indicative of the measured RSRP for each candidate cell. In some cases, the measurement report can include the measured RSRP values of the various candidate cells. In some examples, the measurement report can indicate a ranked order, list, or sequence of the candidate cells according to the RSRP values measured by the UE, without the measurement report including the measured RSRP values. Candidate cell selection can be performed for the UE handover by selecting a candidate cell from the set of candidate cells based on a decreasing order of the measured RSRP determined by the UE. For example, the candidate cell with the best RSRP measurement may be listed first in the measurement report transmitted to the network entity, and may be selected as the target cell in a handover decision determined by the network entity for the UE. In some cases, the UE can perform measurement reporting for the candidate cells for handover or UE mobility as ordered list reporting (e.g., the UE can transmit an ordered list of the candidate cells based on or ranked according to the respective signal strength and/or quality measured by the UE for each respective candidate cell). In some cases, the candidate cell with the best RSRP can be different from the candidate cell with the best throughput.

The systems and techniques described herein can be used to configure UE mobility management to be performed based on factors other than, or in addition to, the RSRP or link quality alone for each candidate cell. For example, the systems and techniques can be used to provide UE candidate cell handover determinations that are implemented using measurement reports that are indicative of throughput information for one or more candidate cells for handover of a UE.

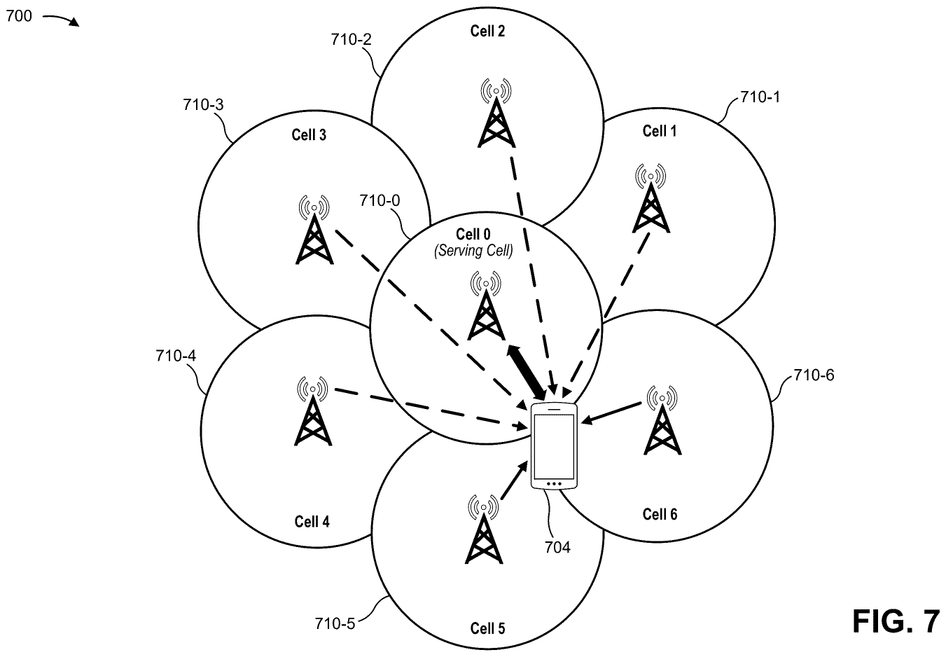

FIG. 7 is a diagram illustrating an example of a configuration of a wireless communication network configuration 700 corresponding to idle UE cell reselection based on respective frequency information for a plurality of neighboring cells, in accordance with some examples. For example, the wireless communication network configuration 700 can correspond to a plurality of different cells, including a ‘Cell 0’ 710-0 configured as a serving cell for a UE 704, a neighboring ‘Cell 1’ 710-1 associated with the UE 704, a neighboring ‘Cell 2’ 710-2 associated with the UE 704, a neighboring ‘Cell 3’ 710-3 associated with the UE 704, a neighboring ‘Cell 4’ 710-4 associated with the UE 704, a neighboring ‘Cell 5’ 710-5 associated with the UE 704, and a neighboring ‘Cell 6’ 710-6 associated with the UE 704, etc. In some examples, the serving cell 710-0 can be the same as or similar to the serving cell 610-0 of FIG. 6. In some cases, the neighboring cells 710-1-710-6 of FIG. 7 can be the same as or similar to one or more of the neighboring cells 610-1 and/or 610-2 of FIG. 6. The UE 704 of FIG. 7 can be the same as or similar to the UE 604 of FIG. 6.

In some cases, the wireless communication network configuration 700 can be associated with frequency priority for idle UE cell reselection. An idle UE may be a UE that is not actively transmitting or receiving data. Idle UEs may be configured to use broadcast information included in one or more System Information Blocks (SIBs) from the network to configure an idle UE cell reselection process to evaluate neighboring cells as candidate cells for handover and/or cell re-selection. In some examples. In some examples, the neighbor cell list included within the SIB broadcast.

For example, the wireless communication network configuration 700 can be a 5G NR cellular network, configured for UE mobility management based on a neighboring cell list for idle UE cell reselection that is broadcast in one or more SIBs by a network entity, base station, gNB, etc. of the wireless communication network configuration 700, where the one or more SIBs are received by the UE 704. In some examples, the neighbor cell list information indicated by a SIB can be the same as or similar to a candidate cell list or candidate cell information associated with UE mobility management and/or handover operations. In some aspects, the neighbor cell list for idle UE cell reselection can be broadcast in SIB, and may be common for all SSBs (e.g., shared by all SSBs, etc.).

In some examples, information indicative of an intra-frequency neighboring cell list can be indicated in SIB3. Information indicative of an inter-frequency neighboring cell list can be indicated in SIB4. In some cases, information indicative of an inter-RAT neighboring cell list can be indicated in SIB5. A common configuration for intra-frequency, inter-frequency, and inter-RAT cell reselection configuration at the UE 704 can be indicated in SIB2. For example, the SIB2 may include information indicative of common configuration parameters for all types of cell reselection at or by the UE 704, etc.

SIB2, SIB3, SIB4, and SIB5 are periodic SIBs (e.g., SIBs other than SIB Type 1 (SIB1). These periodic SIBs may be transmitted by periodic broadcast over DL-SCH, within a periodically occurring time-domain window SI-Window. In one illustrative example, the SIB Type 4 (e.g., SIB4) is used to carry the NR Interfrequency Neighbor cell list and Reselection Criteria information that can be used for inter-frequency cell reselection configuration. For example, SIB4 can include the information elements (IEs):

| InterFreqCarrierFreqInfo ::= SEQUENCE { | |
|---|---|
| InterFreqCarrierFreqInfo ::= SEQUENCE { | |
| dl-CarrierFreq | ARFCN-ValueNR, |
| frequencyBandList | MultiFrequencyBandListNR-SIB |
| OPTIONAL, | |
| [ . . . ] | |
| cellReselectionPriority | CellReselectionPriority OPTIONAL, |
| cellReselectionSubPriority | CellReselectionSubPriority OPTIONAL, |

[ . . . ]
}

In another illustrative example, the SIB Type 5 (e.g., SIB5) is used to carry the Evolved Universal Terrestrial Radio Access (EUTRA) Neighbor cell list and Reselection Criteria information that can be used for inter-RAT cell reselection configuration. For example, SIB5 can include the IEs:

| CarrierFreqEUTRA ::= SEQUENCE { | |
|---|---|
| carrierFreq | ARFCN-ValueEUTRA, |

| [ . . . ] | |
|---|---|
| cellReselectionPriority | CellReselectionPriority OPTIONAL, |
| cellReselectionSubPriority | CellReselectionSubPriority OPTIONAL, |

[ . . . ]
}

In some cases, the network entity (e.g., base station, gNB, etc.) can provide reselection priority information on a per-frequency basis, for example in the case of inter-frequency and/or inter-RAT idle UE cell reselection. In some aspects, the reselection priority per frequency can be implemented based on eight priority levels and four sub-priority levels. For example, the network entity can implement frequency priority for the candidate cell selection based on the network entity broadcasting the reselection priorities for inter-frequency and inter-RAT reselection, where the reselection priorities are categorized into different combinations of the 8 primary priority levels and the 4 sub-priority levels, which can be used for the UE 704 to more efficiently evaluate and select candidate cells for the inter-frequency or inter-RAT reselection and handover.

In one illustrative example, the systems and techniques can be used to extend Lower Layer Trigger Mobility (LTM) to support carrier aggregation (CA) mode operations for a UE associated with the handover or cell switch mobility event. LTM can be implemented as a mobility enhancement for improved handover performance and reduced interruption time for mobile users, based on mobility using lower-layer (e.g., L1 or L2) signaling instead of traditional RRC (L3) signaling to reduce overhead and interruption time during handovers. In some cases, 5G NR Layer One (L1)-triggered mobility may be referred to as NR LTM.

In NR LTM, the network may implement carrier aggregation operations based on the network configuring the UE with one or more candidate CA configurations. For example, the network may implement carrier aggregation and one or more CA configurations concurrently with the UE mobility and cell handover procedures noted above. In one illustrative example, the serving cell 610-0, neighboring candidate cell 610-1, and/or neighboring candidate cell 610-2, etc., of FIG. 6 may be implemented as CA cells each comprising a respective aggregated CA bandwidth of multiple CCs (e.g., may be implemented as CA cells each comprising a respective aggregated CA bandwidth such as the aggregated CA bandwidth 520 of FIG. 5B, etc.).

In another example, one or more of the serving cell 710-0 and/or the neighboring candidate cells 710-1-710-6 of FIG. 7 may be implemented as CA cells each comprising a respective aggregated CA bandwidth of multiple CCs (e.g., may be implemented as CA cells each comprising a respective aggregated CA bandwidth such as the aggregated CA bandwidth 520 of FIG. 5B, etc.).

In NR LTM, for CA operation immediately after UE mobility or cell handover (e.g., cell switch), the candidate CA configurations are already supported. For example, the UE may measure the primary cell (PCell) downlink (DL) RSRP for each candidate CA configuration for performing UE mobility or handover/cell switch to a CA cell. The CA configuration for a CA cell may include additional CCs within its respective aggregated CA bandwidth 520 that are not associated with measured PCell (e.g., additional CCs within the aggregated CA bandwidth 520 correspond to SCells of the CA cell, etc.). In NR LTM, the additional CCs associated with SCells, or more generally, the additional CCs of an aggregated CA bandwidth 520 that do not correspond to the PCell DL are not measured for reference signal link quality during the UE measurements for cell handover or switch. In NR LTM, the UE may be configured to report only the measured PCell DL RSRP for each candidate CA configuration to the network. The network may then initiate cell switch or cell handover to a new candidate CA configuration (e.g., a new candidate CA cell aggregated bandwidth 520, etc.) based on the PCell RSRP measurement report determined by the UE for reference signals on the CC(s) associated with the PCell of the candidate CA configuration aggregated bandwidth.

The systems and techniques described herein can be used to configure the UE to measure, determine, and/or estimate information indicative of or corresponding to one or more link quality or performance parameters of the CA mode operation after performing cell switch or handover to a candidate CA configuration. For example, candidate CA configuration selection for UE mobility events and cell handover or cell switch can be performed based on the UE determining measurement information for each CC of a plurality of CCs indicated in the respective candidate CA configuration for a neighboring CA cell. In some aspects, the UE can receive assistance information from the network and can be configured to estimate the cell throughput of each candidate cell for the handover or switch, including estimating the cell throughput of each candidate CA configuration for a CA cell aggregated bandwidth of a plurality of CCs. In some aspects, network assistance information provided to the UE can be used to estimate each candidate CA operation's performance, based on one or more of a maximum throughput, a quality-of-service (QoS), a latency, etc., determined based on the UE combining the network assistance information and reference signal measurement information.

In one illustrative example, a network entity (e.g., base station, gNB, etc.) can configure one or more UEs with configuration information for reference signal measurement (RS measurement) to support enhanced CA operation immediately after cell switch. For example, the network entity can provide UEs with configuration information indicative of a configuration for the measurement RSs that the UE can use for measuring and estimating the throughput of a candidate CA configuration or candidate CA cell.

A first RS measurement configuration can indicate to the UE that a separate reference signal is provided for each CC within a candidate CA configuration. For example, a separate RS on each CC may be transmitted by the network with a same or different beam (e.g., a respective RS is transmitted for each respective CC of the plurality of CCs within a candidate CA configuration, where the respective RSs may be transmitted with the same Tx beam from the network or may be transmitted with different Tx beams from the network). In the example of FIG. 5B, the first RS measurement configuration indicative of a separate RS on each CC can correspond to a first RS being transmitted by the network entity 102 and measured by the UE 104 on the first CC0 of the aggregated CA bandwidth 520, a second RS being transmitted by network entity 102 and measured by UE 104 on the second CC1 of the aggregated CA bandwidth 520, a third RS being transmitted by the network entity 102 and measured by the UE 104 on the third CC2 of the aggregated CA bandwidth 520, and a fourth RS being transmitted by the network entity 102 and measured by the UE 104 on the fourth CC3 of the aggregated CA bandwidth 520.

In another illustrative example, a second RS measurement configuration may be used, and can indicate that a common reference signal (e.g., configured by the network) will be shared among all the component carriers in a respective or particular candidate CA configuration. For example, the second RS measurement configuration can indicate to the UE 104 of FIG. 5B that a common reference signal is transmitted on each of (e.g., is shared by all of) the four component carriers CC0-CC3 included in the aggregated CA bandwidth 520 of FIG. 5B. In some aspects, the second RS measurement configuration can be indicative of the common reference signal for the CCs of a candidate CA configuration. In some examples, the second RS measurement configuration includes the common reference signal for the CCs of a candidate CA configuration. In some cases, the common reference signal shared across the CCs of a candidate CA configuration may be configured from the network to the UE separately. In some cases, the second RS measurement configuration can correspond to the common RS being transmitted by the network on a subset of CCs of a candidate CA configuration using a same beam. In some aspects, the subset of CCs on which the common RS is transmitted by the network can be indicated or additionally signaled from the network to the UE. In some examples, the subset of CCs can be indicated within the second RS measurement configuration. In some aspects, the subset of CCs can be the subset of CCs within the plurality of CCs included in a candidate CA configuration that share the same Tx beam from the network.

In another illustrative example, a third RS measurement configuration may be used, and can include one or more additional configuration bits per CC of a candidate CA configuration. The configuration bit signaled in the third RS measurement configuration for each respective CC of the plurality of CCs within a candidate CA configuration can indicate whether an RS will be transmitted on the particular CC (e.g., based on the configuration bit for the particular CC having a first value, such as ‘1’), or whether an RS will not be transmitted on the particular CC (e.g., based on the configuration bit for the particular CC having a second value, such as ‘0’).

In some aspects, if the RS measurement configuration information includes a configuration bit mapped to a particular CC within a respective candidate CA configuration, where the configuration bit indicates no RS transmission will be performed for the particular CC, then the UE may be configured to estimate one or more UL/DL link quality and/or throughput metrics on the particular CC. For example, if the configuration bit indicates no RS transmission will be performed for the particular CC, the UE can be configured to estimate one or more of an RSRP, a throughput, an expected QoS, etc., on the particular CC. The link quality (e.g., RSRP, throughput, expected QoS, etc.) estimate on a particular CC that does not receive an RS transmission can be performed by the UE based on the UE obtaining RS measurements on the PCell and corresponding CC(s) of the CA candidate configuration where an RS transmission is performed.

Based on the UE receiving, from the network, at least one of the first RS measurement configuration (e.g., indicating a separate RS transmitted on each CC of a candidate CA configuration), the second RS measurement configuration (e.g., indicating a common RS transmitted on each CC or a subset of CCs of a candidate CA configuration), or the third RS measurement configuration (e.g., a mapped bit per-CC indicating if RS transmission is performed for the mapped CC), the UE can measure and/or estimate link quality information for one or more CCs of the candidate CA configuration.

In one illustrative example, at least one CC of the one or more CCs of the candidate CA configuration for which the UE measures or estimates link quality or throughput information is not the primary CC corresponding to the PCell of the candidate CA configuration. For example, the systems and techniques can cause the UE to measure or estimate link quality and/or throughput information for at least one CC of a candidate CA configuration where the at least one CC is a non-primary CC/non-PCell CC of the candidate CA configuration.

In some aspects, the network (e.g., network entity, base station, gNB, etc.) can transmit the RS measurement configuration to a UE, and may additionally configure, transmit, or provide network assistance information for enhanced CA operation at the UE immediately after cell switch. For example, the network entity can provide a UE with separate RS measurement configuration information and network assistance information, where the network assistance information is indicative of an existing cell load per CC (e.g., indicating one or more of a quantity of resources available for use on the CC as DL-only, a quantity of resources available for use on the CC as UL-only, a quantity of resources available for use on the CC as joint UL/DL resources, etc.). In some examples, the network assistance information can indicate an existing cell load per CC as a first percentage of the resources of the CC available for DL and/or a second percentage of the resources of the CC available for UL.

In some aspects, the network assistance information is indicative of noise information per CC of a candidate CA configuration, and/or interference tolerance per CC of the candidate CA configuration. For example, the noise figure and/or interference tolerance per CC information indicated in the network assistance information can be used by the UE to estimate the UL throughput in a CC suitable for UL in the candidate CA configuration.

In some examples, the network assistance information can be indicative of the available resources per CC for a new user. For example, the network assistance information can indicate a percentage value of available time/frequency resources per CC for a new user, a number of RBs per CC for a new user, a number of slots per frame for DL-only, UL-only, and/or joint DL/UL per CC for a new user, etc.

In some aspects, the network assistance information can be indicative of statistics of expected QoS per CC within a candidate CA configuration. For example, the network assistance information may be indicative of one or more of an average QoS, a minimum QoS, a maximum QoS, a percentile value of expected QoS, etc., that may be guaranteed in that CC within the candidate CA configuration for the potential UE handover/cell switch to the candidate CA configuration aggregated CA bandwidth.

In some examples, the systems and techniques can be used to provide one or more dynamic updates to one or more (or both) of the RS measurement configuration and/or the network assistance information for the enhanced CA operation immediately after cell switch. For example, the one or more dynamic updates can be implemented by the serving cell of the UE, using one or more of a DCI indicative of the dynamic update information for the RS measurement configuration and/or network assistance information, a MAC-CE indicative of the dynamic update information for the RS measurement configuration and/or network assistance information, a SIB indicative of the dynamic update information for the RS measurement configuration and/or network assistance information, and/or a Master Information Block (MIB) indicative of the dynamic update information for the RS measurement configuration and/or network assistance information, etc.

In some aspects, the dynamic update information can be signaled as a dynamic update signal included within one or more of the DCI, MAC-CE, SIB, and/or MIB, etc., transmitted from the serving cell to the UE. The dynamic update signal can be indicative of a target candidate ID of one or more particular or respective candidate CA configuration (of the plurality of candidate CA configurations associated with or neighboring to the UE) for which the dynamic update applies and/or a target candidate ID of one or more particular CCs within a respective candidate CA configuration of the plurality of candidate CA configurations associated with the UE. In some cases, the target candidate ID information can identify or correspond to a subset of the plurality of CC candidate IDs included within a respective candidate CA configuration.

In some aspects, the dynamic update signal may be indicative of a CC reference where the dynamic update is applicable. In some cases, the dynamic update signal can be indicative of and/or may include an additional RS measurement configuration for the target candidate. For example, the additional RS measurement configuration can indicate one or more new RS configurations for the UE to measure on one or more CCs of one or more candidate CA configurations comprising neighboring cells of the UE for potential UE mobility, handover, cell switch, etc. In some examples, the dynamic update signal can be indicative of a change in status of an RS from transmitted to non-transmitted, or from non-transmitted to transmitted, on a per-CC-basis of the target candidate CA configuration identified by the target candidate CA information.

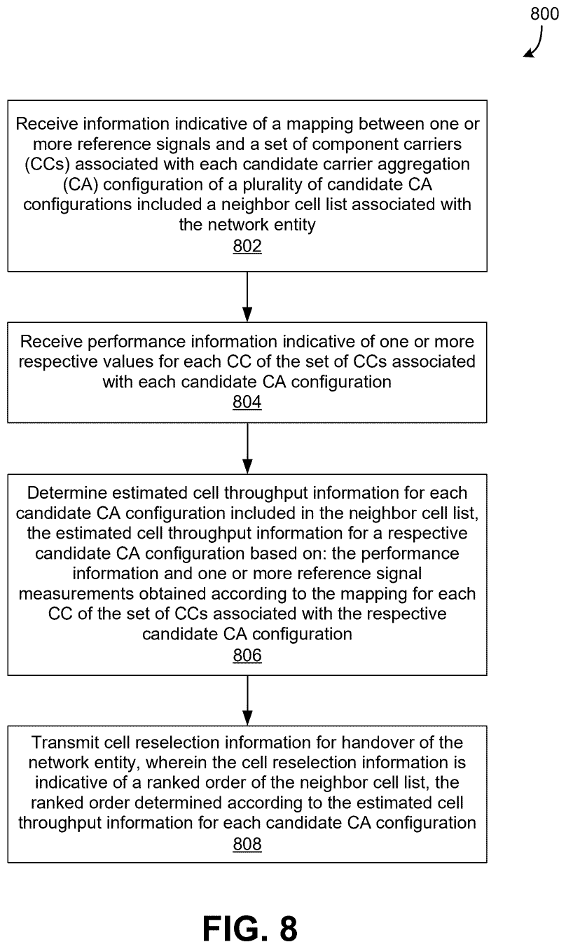

FIG. 8 is a flowchart diagram illustrating an example of a process 800 for wireless communications. In some aspects, the process 800 can be a process for wireless communications by a network entity (e.g., a UE, etc.). For example, the process 800 can be a process for wireless communications by a UE. In some examples, the process 800 can be performed by a network entity or network device (or apparatus) or a component (e.g., a chipset, codec, etc.) of the network entity or device. The process 800 can be performed by one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the network entity or device or apparatus. The operations of the process 800 may be implemented as software components that are executed and run on one or more processors (e.g., processor 910 and/or processing system 902 of FIG. 9, or other processor(s)).

In some examples, the process 800 can be performed by a UE, including any of the UEs of FIGS. 1-7. In some aspects, the process 800 can be performed by a UE, smartphone, mobile computing device, user computer device, etc. The process 800 can be performed by a component or system (e.g., a chipset) of a network device (e.g., one or more of UEs 104, 152, 164, 182, 190 of FIG. 1; UE 104 of FIG. 2; UE(s) 104 of FIG. 3; wireless device 407 of FIG. 4; computing system 900 and/or processing system 902 of FIG. 9; etc.). The network device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1000 may be implemented as software components that are executed and run on one or more processors (e.g., the transmit processor 264, the receive processor 258, the TX MIMO processor 266, the MIMO detector 256 of FIG. 2, the processing system 470 of FIG. 4, the processor(s) 484 of FIG. 4, the processing system 902 of FIG. 9, and/or the processor 910 of FIG. 9, or other processor(s) (e.g., such as one or more other processors included within and/or associated with the processing system 470 of FIG. 4, the processing system 902 of FIG. 9, etc.). Further, the transmission and reception of signals by the network entity in the process 800 may be enabled, for example, by one or more antennas, one or more transceivers (e.g., wireless transceiver(s)), and/or other communication components (e.g., the transmit processor 264, the receive processor 258, the TX MIMO processor 266, the MIMO detector 256, the modulator(s)/demodulator(s) 254a through 254t, and/or the antenna(es) 252a through 252t of FIG. 2, the antenna(es) 487 of FIG. 4, the wireless transceiver(s) 478 of FIG. 4, the communication interface 940 of FIG. 9, or other antennae(s), transceiver(s), and/or component(s)).

At block 802, the network entity (or component thereof) can receive information indicative of a mapping between one or more reference signals and a set of component carriers (CCs) associated with each candidate carrier aggregation (CA) configuration of a plurality of candidate CA configurations included a neighbor cell list associated with the network entity. For example, the mapping can correspond to the CCs CC0, CC1, CC2, CC3 associated with the CA configuration 520 of FIG. 5B. In some examples, the network entity can be a UE, such as the UE 604 of FIG. 6. The neighbor cell list can correspond to one or more neighbor cells, such as the neighbor cell 610-1 and/or 610-2 of FIG. 6 that are associated with a current serving cell 610-0 of FIG. 6.

In some cases, the neighbor cell list is associated with cell reselection or handover of the network entity from a first serving cell to a selected serving cell determined from the neighbor cell list. For example, the neighbor cell list can be associated with handover of the UE 604 from the serving cell 610-0 to a selected serving cell comprising one of neighbor cells 610-1 and 610-2. In some cases, the neighbor cell list can be associated with handover of the UE 704 of FIG. 7 from a serving cell 710-0 to a selected serving cell comprising one of the neighbor cells 710-2, 710-3, 710-4, 710-5, 710-6 included in a neighbor cell list.

In some examples, the mapping comprises a reference signal measurement configuration indicative of corresponding reference signals transmitted on one or more CCs of the set of CCs associated with each candidate CA configuration. In some cases, the mapping is indicative of a corresponding reference signal transmitted on each respective CC of the set of CCs for each candidate CA configuration. In some examples, to receive the information indicative of the mapping, the network entity (or component thereof) is configured to receive information indicative of a common reference signal shared on the set of CCs.

In some cases, the network entity (or component thereof) can be configured to receive the common reference signal using a same beam on a subset of CCs of the set of CCs. In some examples, the information indicative of the mapping includes an indication of the subset of CCs. In some cases, the mapping comprises a respective mapping bit for each CC of the set of CCs. For example, a first value of the respective mapping bit for a particular CC can be indicative of reference signal transmission on the particular CC. A second value of the respective mapping bit can be indicative of no reference signal transmission on the particular CC.

At block 804, the network entity (or component thereof) can receive performance information indicative of one or more respective values for each CC of the set of CCs associated with each candidate CA configuration. For example, the network entity can be a user equipment (UE), and the performance information and the information indicative of the mapping can be received in one or more respective signals received by the UE from a second network entity associated with the UE. In some cases, the second network entity can be a base station that transmits the performance information for each CC to the UE. In some cases, to transmit the cell reselection information, the network entity (or component thereof) (e.g., the UE) can be configured to transmit the cell reselection information to the base station.

In some examples, the network entity (or component thereof) can be configured to receive, from the second network entity, a handover configuration configured to cause the network entity (or component thereof) to perform a cell switch from a first serving cell not included in the neighbor cell list to a target candidate cell comprising a particular candidate CA configuration selected from the neighbor cell list based on being first in the ranked order.

In some cases, to receive the performance information, the network entity (or component thereof) can be configured to receive at least one of: information indicative of a respective cell load for each CC of the set of CCs, information indicative of a noise or interference tolerance associated with each CC of the set of CCs, information indicative of available resources for each CC of the set of CCs, and/or information indicative of estimated Quality-of-Service (QoS) associated with each CC of the set of CCs. In some cases, the performance information comprises respective input values configured for throughput estimation by the network entity for each CC of the set of CCs.

At block 806, the network entity (or component thereof) can determine estimated cell throughput information for each candidate CA configuration included in the neighbor cell list, the estimated cell throughput information for a respective candidate CA configuration based on: the performance information and one or more reference signal measurements obtained according to the mapping for each CC of the set of CCs associated with the respective candidate CA configuration.

At block 808, the network entity (or component thereof) can transmit cell reselection information for handover of the network entity, wherein the cell reselection information is indicative of a ranked order of the neighbor cell list, the ranked order determined according to the estimated cell throughput information for each candidate CA configuration.

In some cases, the network entity (or component thereof) can be further configured to receive an update signal indicative of at least one of an updated reference signal measurement configuration comprising a dynamic update to the mapping, and/or an updated performance information indicative of updated throughput information for one or more CCs of the set of CCs. In some cases, to receive the update signal, the network entity (or component thereof) can be configured to receive a transmission from a serving cell of the network entity. The transmission may comprise at least one of: a downlink control information (DCI), a media access control (MAC)-control element (MAC-CE), a system information block (SIB), or a master information block (MIB).

In some cases, the transmission includes an identifier of one or more CCs associated with a particular candidate CA configuration. The update signal can be applicable for the one or more CCs. In some examples, the transmission can include an additional reference signal configuration information corresponding to the one or more CCs. For example, the additional reference signal configuration information can be indicative of a first change in status from reference signal transmission to no reference signal transmission. In another example, the additional reference signal configuration information can be indicative of a second change in status from no reference signal transmission to reference signal transmission.

In some examples, the processes described herein (e.g., process 800 and/or other process described herein) may be performed by a computing device or apparatus (e.g., a network node such as a UE, base station, a portion of a base station, etc.). For instance, as noted above, the process 800 may be performed by a UE. In another example, the process 800 may be performed by a computing device with the computing system 900 shown in FIG. 9. For instance, a wireless communication device with the computing architecture shown in FIG. 9 may include the components of the UE and/or the network entity (e.g., base station, gNB, etc.) and may implement the operations of FIG. 8.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 800 is illustrated as a logical flow diagram, the operation of which represents a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 800 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a diagram illustrating an example of a system for implementing certain aspects of the present technology. In particular, FIG. 9 illustrates an example of computing system 900 including a processing system 902, which may be for example any computing device making up internal computing system, a remote computing system, a camera, or any component thereof in which the components of the system are in communication with each other using connection 905. Connection 905 may be a physical connection using a bus, or a direct connection into processor 910 (and/or one or more other processors included within and/or associated with the processing system 902), such as in a chipset architecture. Connection 905 may also be a virtual connection, networked connection, or logical connection.

In some aspects, computing system 900 and/or the processing system 902 can be provided as a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

The example processing system 902 includes at least one processing unit (CPU or processor) 910 and connection 905 that communicatively couples various system components including system memory 915, such as read-only memory (ROM) 920 and random access memory (RAM) 925 to processor 910. The processing system 902 may include a cache 912 of high-speed memory connected directly with, in close proximity to, or integrated as part of processor 910 and/or one or more other processors included within and/or associated with the processing system 902.

Processor 910 may include any general-purpose processor and a hardware service or software service, such as services 932, 934, and 936 stored in storage device 930, configured to control processor 910 and/or one or more other processors included within and/or associated with the processing system 902, as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, processing system 902 includes an input device 945, which may represent any number of input mechanisms, such as a microphone for speech, a touch-sensitive screen for gesture or graphical input, keyboard, mouse, motion input, speech, etc. Processing system 902 may also include output device 935, which may be one or more of a number of output mechanisms. In some instances, multimodal systems may enable a user to provide multiple types of input/output to communicate with processing system 902.

Processing system 902 may include communications interface 940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910 and/or one or more other processors included within and/or associated with the processing system 902, it causes the system to perform a function. In some aspects, a hardware service that performs a particular function may include the software component stored in a computer-readable medium in connection with the necessary hardware components, such as processor 910 (e.g., and/or one or more other processors included within and/or associated with the processing system 902), connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. A network entity for wireless communication, comprising: a processing system configured to: receive information indicative of a mapping between one or more reference signals and a set of component carriers (CCs) associated with each candidate carrier aggregation (CA) configuration of a plurality of candidate CA configurations included a neighbor cell list associated with the network entity; receive performance information indicative of one or more respective values for each CC of the set of CCs associated with each candidate CA configuration; determine estimated cell throughput information for each candidate CA configuration included in the neighbor cell list, the estimated cell throughput information for a respective candidate CA configuration based on: the performance information and one or more reference signal measurements obtained according to the mapping for each CC of the set of CCs associated with the respective candidate CA configuration; and transmit cell reselection information for handover of the network entity, wherein the cell reselection information is indicative of a ranked order of the neighbor cell list, the ranked order determined according to the estimated cell throughput information for each candidate CA configuration.
Aspect 2. The network entity of Aspect 1, wherein the mapping comprises a reference signal measurement configuration indicative of corresponding reference signals transmitted on one or more CCs of the set of CCs associated with each candidate CA configuration.
Aspect 3. The network entity of any of Aspects 1 to 2, wherein the mapping is indicative of a corresponding reference signal transmitted on each respective CC of the set of CCs for each candidate CA configuration.
Aspect 4. The network entity of any of Aspects 1 to 3, wherein, to receive the information indicative of the mapping, the processing system is configured to: receive information indicative of a common reference signal shared on the set of CCs.
Aspect 5. The network entity of Aspect 4, wherein the processing system is configured to receive the common reference signal using a same beam on a subset of CCs of the set of CCs.
Aspect 6. The network entity of Aspect 5, wherein the information indicative of the mapping includes an indication of the subset of CCs.
Aspect 7. The network entity of any of Aspects 1 to 6, wherein the mapping comprises a respective mapping bit for each CC of the set of CCs, where a first value of the respective mapping bit for a particular CC is indicative of reference signal transmission on the particular CC, and wherein a second value of the respective mapping bit is indicative of no reference signal transmission on the particular CC.
Aspect 8. The network entity of any of Aspects 1 to 7, wherein, to receive the performance information, the processing system is configured to receive at least one of: information indicative of a respective cell load for each CC of the set of CCs; information indicative of a noise or interference tolerance associated with each CC of the set of CCs; information indicative of available resources for each CC of the set of CCs; or information indicative of estimated Quality-of-Service (QoS) associated with each CC of the set of CCs.
Aspect 9. The network entity of any of Aspects 1 to 8, wherein the performance information comprises respective input values configured for throughput estimation by the network entity for each CC of the set of CCs.
Aspect 10. The network entity of any of Aspects 1 to 9, wherein the processing system is further configured to receive an update signal indicative of at least one of: an updated reference signal measurement configuration comprising a dynamic update to the mapping; or an updated performance information indicative of updated throughput information for one or more CCs of the set of CCs.
Aspect 11. The network entity of Aspect 10, wherein: to receive the update signal, the processing system is configured to receive a transmission from a serving cell of the network entity; and the transmission comprises at least one of: a downlink control information (DCI), a media access control (MAC)-control element (MAC-CE), a system information block (SIB), or a master information block (MIB).
Aspect 12. The network entity of Aspect 11, wherein the transmission includes at least one of: an identifier of one or more CCs associated with a particular candidate CA configuration, wherein the update signal is applicable for the one or more CCs; and additional reference signal configuration information corresponding to the one or more CCs, wherein the additional reference signal configuration information is indicative of a first change in status from reference signal transmission to no reference signal transmission, or a second change in status from no reference signal transmission to reference signal transmission.
Aspect 13. The network entity of any of Aspects 1 to 12, wherein the neighbor cell list is associated with cell reselection or handover of the network entity from a first serving cell to a selected serving cell determined from the neighbor cell list.
Aspect 14. The network entity of any of Aspects 1 to 13, wherein: the network entity is a user equipment (UE); and the processing system is configured to receive the performance information and the information indicative of the mapping in one or more respective signals received by the UE from a second network entity associated with the UE.
Aspect 15. The network entity of Aspect 14, wherein the second network entity is a base station, and wherein to transmit the cell reselection information, the processing system is configured to transmit the cell reselection information to the base station.
Aspect 16. The network entity of Aspect 15, wherein the processing system is configured to receive, from the second network entity, a handover configuration configured to cause the network entity to perform a cell switch from a first serving cell not included in the neighbor cell list to a target candidate cell comprising a particular candidate CA configuration selected from the neighbor cell list based on being first in the ranked order.
Aspect 17. A method for wireless communication, comprising: receiving information indicative of a mapping between one or more reference signals and a set of component carriers (CCs) associated with each candidate carrier aggregation (CA) configuration of a plurality of candidate CA configurations included a neighbor cell list associated with a network entity; receiving performance information indicative of one or more respective values for each CC of the set of CCs associated with each candidate CA configuration; determining estimated cell throughput information for each candidate CA configuration included in the neighbor cell list, the estimated cell throughput information for a respective candidate CA configuration based on: the performance information and one or more reference signal measurements obtained according to the mapping for each CC of the set of CCs associated with the respective candidate CA configuration; and transmitting cell reselection information for handover of the network entity, wherein the cell reselection information is indicative of a ranked order of the neighbor cell list, the ranked order determined according to the estimated cell throughput information for each candidate CA configuration.
Aspect 18. The method of Aspect 17, wherein the mapping comprises a reference signal measurement configuration indicative of corresponding reference signals transmitted on one or more CCs of the set of CCs associated with each candidate CA configuration.
Aspect 19. The method of any of Aspects 17 to 18, wherein the mapping is indicative of a corresponding reference signal transmitted on each respective CC of the set of CCs for each candidate CA configuration.
Aspect 20. The method of any of Aspects 17 to 19, wherein receiving the information indicative of the mapping includes: receiving information indicative of a common reference signal shared on the set of CCs.
Aspect 21. The method of Aspect 20, wherein the common reference signal is received using a same beam on a subset of CCs of the set of CCs.
Aspect 22. The method of Aspect 21, wherein the information indicative of the mapping includes an indication of the subset of CCs.
Aspect 23. The method of any of Aspects 17 to 22, wherein the mapping comprises a respective mapping bit for each CC of the set of CCs, where a first value of the respective mapping bit for a particular CC is indicative of reference signal transmission on the particular CC, and wherein a second value of the respective mapping bit is indicative of no reference signal transmission on the particular CC.
Aspect 24. The method of any of Aspects 17 to 23, wherein receiving the performance information includes receiving at least one of: information indicative of a respective cell load for each CC of the set of CCs; information indicative of a noise or interference tolerance associated with each CC of the set of CCs; information indicative of available resources for each CC of the set of CCs; or information indicative of estimated Quality-of-Service (QoS) associated with each CC of the set of CCs.
Aspect 25. The method of any of Aspects 17 to 24, wherein the performance information comprises respective input values configured for throughput estimation by the network entity for each CC of the set of CCs.
Aspect 26. The method of any of Aspects 17 to 25, further comprising receiving an update signal indicative of at least one of: an updated reference signal measurement configuration comprising a dynamic update to the mapping; or an updated performance information indicative of updated throughput information for one or more CCs of the set of CCs.
Aspect 27. The method of Aspect 26, wherein: receiving the update signal comprises receiving a transmission from a serving cell of the network entity; and the transmission comprises at least one of: a downlink control information (DCI), a media access control (MAC)-control element (MAC-CE), a system information block (SIB), or a master information block (MIB).
Aspect 28. The method of Aspect 27, wherein the transmission includes of: an identifier of one or more CCs associated with a particular candidate CA configuration, wherein the update signal is applicable for the one or more CCs; and additional reference signal configuration information corresponding to the one or more CCs, wherein the additional reference signal configuration information is indicative of a first change in status from reference signal transmission to no reference signal transmission, or a second change in status from no reference signal transmission to reference signal transmission.
Aspect 29. The method of any of Aspects 17 to 28, wherein the neighbor cell list is associated with cell reselection or handover of the network entity from a first serving cell to a selected serving cell determined from the neighbor cell list.
Aspect 30. The method of any of Aspects 17 to 29, wherein: the network entity is a user equipment (UE); and the performance information and the information indicative of the mapping are received in one or more respective signals received by the UE from a second network entity associated with the UE.
Aspect 31. The method of Aspect 30, wherein the second network entity is a base station, and wherein to transmitting the cell reselection information comprises transmitting the cell reselection information to the base station.
Aspect 32. The method of Aspect 31, further comprising receiving from the second network entity, a handover configuration configured to cause the network entity to perform a cell switch from a first serving cell not included in the neighbor cell list to a target candidate cell comprising a particular candidate CA configuration selected from the neighbor cell list based on being first in the ranked order.
Aspect 33. A non-transitory computer-readable storage medium comprising instructions stored thereon which, when executed by at least one processor, causes the at least one processor to: receive information indicative of a mapping between one or more reference signals and a set of component carriers (CCs) associated with each candidate carrier aggregation (CA) configuration of a plurality of candidate CA configurations included a neighbor cell list associated with a network entity; receive performance information indicative of one or more respective values for each CC of the set of CCs associated with each candidate CA configuration; determine estimated cell throughput information for each candidate CA configuration included in the neighbor cell list, the estimated cell throughput information for a respective candidate CA configuration based on: the performance information and one or more reference signal measurements obtained according to the mapping for each CC of the set of CCs associated with the respective candidate CA configuration; and transmit cell reselection information for handover of the network entity, wherein the cell reselection information is indicative of a ranked order of the neighbor cell list, the ranked order determined according to the estimated cell throughput information for each candidate CA configuration.
Aspect 34. A non-transitory computer-readable storage medium comprising instructions stored thereon which, when executed by at least one processor, causes the at least one processor to perform operations according to any of Aspects 1 to 16.
Aspect 35. An apparatus for wireless communication comprising one or more means for performing operations according to any of Aspects 1 to 16.

What is claimed is:

1. A network entity for wireless communication, comprising:
a processing system configured to:
receive information indicative of a mapping between one or more reference signals and a set of component carriers (CCs) associated with each candidate carrier aggregation (CA) configuration of a plurality of candidate CA configurations included a neighbor cell list associated with the network entity;
receive performance information indicative of one or more respective values for each CC of the set of CCs associated with each candidate CA configuration;
determine estimated cell throughput information for each candidate CA configuration included in the neighbor cell list, the estimated cell throughput information for a respective candidate CA configuration based on: the performance information and one or more reference signal measurements obtained according to the mapping for each CC of the set of CCs associated with the respective candidate CA configuration; and
transmit cell reselection information for handover of the network entity, wherein the cell reselection information is indicative of a ranked order of the neighbor cell list, the ranked order determined according to the estimated cell throughput information for each candidate CA configuration.

2. The network entity of claim 1, wherein the mapping comprises a reference signal measurement configuration indicative of corresponding reference signals transmitted on one or more CCs of the set of CCs associated with each candidate CA configuration.

3. The network entity of claim 1, wherein the mapping is indicative of a corresponding reference signal transmitted on each respective CC of the set of CCs for each candidate CA configuration.

4. The network entity of claim 1, wherein, to receive the information indicative of the mapping, the processing system is configured to:
receive information indicative of a common reference signal shared on the set of CCs.

5. The network entity of claim 4, wherein the processing system is configured to receive the common reference signal using a same beam on a subset of CCs of the set of CCs.

6. The network entity of claim 5, wherein the information indicative of the mapping includes an indication of the subset of CCs.

7. The network entity of claim 1, wherein the mapping comprises a respective mapping bit for each CC of the set of CCs, where a first value of the respective mapping bit for a particular CC is indicative of reference signal transmission on the particular CC, and wherein a second value of the respective mapping bit is indicative of no reference signal transmission on the particular CC.

8. The network entity of claim 1, wherein, to receive the performance information, the processing system is configured to receive at least one of:
information indicative of a respective cell load for each CC of the set of CCs;
information indicative of a noise or interference tolerance associated with each CC of the set of CCs;
information indicative of available resources for each CC of the set of CCs; or
information indicative of estimated Quality-of-Service (QOS) associated with each CC of the set of CCs.

9. The network entity of claim 1, wherein the performance information comprises respective input values configured for throughput estimation by the network entity for each CC of the set of CCs.

10. The network entity of claim 1, wherein the processing system is further configured to receive an update signal indicative of at least one of:
an updated reference signal measurement configuration comprising a dynamic update to the mapping; or
an updated performance information indicative of updated throughput information for one or more CCs of the set of CCs.

11. The network entity of claim 10, wherein:
to receive the update signal, the processing system is configured to receive a transmission from a serving cell of the network entity; and
the transmission comprises at least one of: a downlink control information (DCI), a media access control (MAC)-control element (MAC-CE), a system information block (SIB), or a master information block (MIB).

12. The network entity of claim 11, wherein the transmission includes at least one of:
an identifier of one or more CCs associated with a particular candidate CA configuration, wherein the update signal is applicable for the one or more CCs; and
additional reference signal configuration information corresponding to the one or more CCs, wherein the additional reference signal configuration information is indicative of a first change in status from reference signal transmission to no reference signal transmission, or a second change in status from no reference signal transmission to reference signal transmission.

13. The network entity of claim 1, wherein the neighbor cell list is associated with cell reselection or handover of the network entity from a first serving cell to a selected serving cell determined from the neighbor cell list.

14. The network entity of claim 1, wherein:
the network entity is a user equipment (UE); and
the processing system is configured to receive the performance information and the information indicative of the mapping in one or more respective signals received by the UE from a second network entity associated with the UE.

15. The network entity of claim 14, wherein the second network entity is a base station, and wherein to transmit the cell reselection information, the processing system is configured to transmit the cell reselection information to the base station.

16. The network entity of claim 15, wherein the processing system is configured to receive, from the second network entity, a handover configuration configured to cause the network entity to perform a cell switch from a first serving cell not included in the neighbor cell list to a target candidate cell comprising a particular candidate CA configuration selected from the neighbor cell list based on being first in the ranked order.

17. A method for wireless communication, comprising:
receiving information indicative of a mapping between one or more reference signals and a set of component carriers (CCs) associated with each candidate carrier aggregation (CA) configuration of a plurality of candidate CA configurations included a neighbor cell list associated with a network entity;
receiving performance information indicative of one or more respective values for each CC of the set of CCs associated with each candidate CA configuration;
determining estimated cell throughput information for each candidate CA configuration included in the neighbor cell list, the estimated cell throughput information for a respective candidate CA configuration based on: the performance information and one or more reference signal measurements obtained according to the mapping for each CC of the set of CCs associated with the respective candidate CA configuration; and
transmitting cell reselection information for handover of the network entity, wherein the cell reselection information is indicative of a ranked order of the neighbor cell list, the ranked order determined according to the estimated cell throughput information for each candidate CA configuration.

18. The method of claim 17, wherein the mapping comprises a reference signal measurement configuration indicative of corresponding reference signals transmitted on one or more CCs of the set of CCs associated with each candidate CA configuration.

19. The method of claim 17, wherein the mapping is indicative of a corresponding reference signal transmitted on each respective CC of the set of CCs for each candidate CA configuration.

20. A non-transitory computer-readable storage medium comprising instructions stored thereon which, when executed by at least one processor, causes the at least one processor to:
receive information indicative of a mapping between one or more reference signals and a set of component carriers (CCs) associated with each candidate carrier aggregation (CA) configuration of a plurality of candidate CA configurations included a neighbor cell list associated with a network entity;
receive performance information indicative of one or more respective values for each CC of the set of CCs associated with each candidate CA configuration;
determine estimated cell throughput information for each candidate CA configuration included in the neighbor cell list, the estimated cell throughput information for a respective candidate CA configuration based on: the performance information and one or more reference signal measurements obtained according to the mapping for each CC of the set of CCs associated with the respective candidate CA configuration; and
transmit cell reselection information for handover of the network entity, wherein the cell reselection information is indicative of a ranked order of the neighbor cell list, the ranked order determined according to the estimated cell throughput information for each candidate CA configuration.
